(19) United States
(12) Patent Application Publication
(10) Pub. No.: US 2012/0272326 A1
(43) Pub. Date: Oct. 25, 2012

(54) TOKENIZATION SYSTEM

(75) Inventors: SATOSHI KAI, Yokohama (JP); Tetsuro Kito, Yokohama (JP); Hisashi Umeki, Kawasaki (JP); Satoshi Takemoto, Chigasaki (JP)

(73) Assignee: Hitachi, Ltd.

(21) Appl. No.: 13/360,569

(22) Filed: Jan. 27, 2012

(30) Foreign Application Priority Data
Apr. 19, 2011 (JP) 2011-092627

(51) Int. Cl. G06F 21/24

(52) U.S. Cl. 726/26

(57) ABSTRACT

A tokenization unit that tokenizes a real name ID to a different tokenized ID according to a user's service usage situation, a service history analyzing unit that analyzes service history data, a tokenized ID checking unit that determines whether different tokenized IDs are the same in analyzing a plurality of items of service history data including the different tokenized IDs, and a tokenization change management unit that manages a service usage situation the same as that of tokenization by the tokenization unit. The service history analyzing unit performs: a predetermined service history analysis if a target is a service usage situation in which the same tokenized ID appears; and a predetermined service history analysis as different tokenized IDs are considered to be the same user by the tokenized ID checking unit if a target is a service usage situation in which a different tokenized ID appears.

### CLAIM OF PRIORITY

The present application claims priority from Japanese application serial no. JP2011-092627, filed on Apr. 19, 2011, the content of which is hereby incorporated by reference into this application.

### BACKGROUND OF THE INVENTION

1. Field of the Invention

A subject disclosed in the present specification relates to privacy protection technique and a tokenization system that implements privacy protection for user IDs.

2. Description of the Related Arts

In these years, with the spread of information technology to corporate activities and social life, the presentation of an ID linked to a user is increasing in utilizing various IT services such as electronic commerce services and public services. For example, an ID made up of 16-digit numerical characters is used to link a user to a credit card number, and an ID made up of 11-digit numerical characters is used to link a user to a basic residents' registration card. In addition to these, specific examples of IDs are broad such as passport numbers, license numbers, employee numbers assigned by companies, and student numbers assigned by schools. From the viewpoint of a system, an ID is accepted to uniquely identify a user and to offer services suited for the user.

On the other hand, in offering such services, usage history is often recorded when, where, to whom, and what services are offered. An ID is often used for indicating “whom”. A service provider records the usage history of a user, so that the service provider often uses the usage history as evidence for charging the user and as marketing analysis for improving services. Particularly in recent years, offering fine services according to the tendency of a user, seasons, regions, or the like is increasing by analysis of past usage history.

Since the analysis of usage history requires a large amount of resources in terms of storage capacity and computational complexity, there are an increasing number of opportunities to outsource analysis because resources in a company are not enough for analysis. The use of services called business intelligence services and data warehouses is also increasing. However, outsourcing causes less security control in viewpoint of a company, and outsourcing increases leakage risks. Thus, privacy protection for IDs included in usage history is a problem.

According to International Publication No. WO/2008/144555, it is described that in IDs for credit card numbers, the credit card number of a credit card is tokenized on a POS terminal that reads the credit card and the tokenized credit number is used to record usage history (a log) after the tokenization. It is further described that a server is provided to manage correspondences between tokenized credit card numbers and real name credit card numbers to allow the conversion of a tokenized name into a real name. The tokenization of IDs according to International Publication No. WO/2008/144555 makes it impossible to find out to whom an ID belongs by seeing only the ID included in usage history.

### SUMMARY OF THE INVENTION

However, since a large amount of usage history is accumulated over time, a large amount of usage history is checked to allow linking how the tokenized ID of an ID uses services, even though it is impossible to find out to whom the ID belongs from an item of usage history. Thus, there is a possibility to find out to whom the tokenized ID belongs by linking a method of using services in a characteristic manner assumed beforehand.

In paragraph 0116 of International Publication No. WO/2008/144555, it is described that continuous numerical characters are added in generating a tokenized ID and that a tokenized ID is generated randomly or continuously using a date and time, transaction number, or the like, or by an algorithm-like method combining them. However, even though a tokenized ID is generated randomly, continuously, or by an algorithm-like method, it is uncertain whether the tokenized ID is suited for analyzing usage history. In the worst case, it takes time and effort to convert the tokenized ID, which is tokenized with effort, into a real name every time when analyzing usage history.

In the present specification, there is a disclosed tokenization system that can make it difficult to link a tokenized ID included in usage history and can highly efficiently analyze usage history.

A tokenization system to be disclosed is a tokenization system to tokenize a real name ID in generating a user's service history data, for example, the tokenization system including: a tokenization unit configured to tokenize a real name ID to a different tokenized ID according to a situation in which a user uses a service; a service history analyzing unit configured to analyze service history data; a tokenized ID checking unit configured to determine whether different tokenized IDs are the same in analyzing a plurality of items of service history data including the different tokenized IDs; and a tokenization change management unit configured to manage a different tokenized ID according to a service usage situation in association with the service usage situation. The service history analyzing unit performs: a predetermined service history analysis if a target is a service usage situation in which the same tokenized ID appears; and a predetermined service history analysis for a different tokenized ID that is considered to be the same user by the tokenized ID checking unit if a target is a service usage situation in which a different tokenized ID appears.

The tokenization unit may tokenize a real name ID to a different tokenized ID according to a combination of any one or more of a date and time in using a service, a region in using a service, and a user attribute in using a service.

The tokenization change management unit, according to an analysis range in which an analysis is made in the service history analyzing unit, may find a service usage situation close to the analysis range, and prepare a subset of a tokenized ID appearing in the service usage situation; and the tokenized ID checking unit may make a check against the subset of the tokenized ID in order closer to the analysis range.

When sequentially making a check against the subset of the tokenized ID in order closer to the analysis range, the tokenized ID checking unit may make a check against a universal set of a tokenized ID as a last order, or cancel a check on a way of checking in sequentially making a check against the subset of the tokenized ID.

The service history data may include a user ID, a service usage details, and a combination of any one or more of a date and time, a region, and a user attribute.

In the case where the tokenization system includes a service terminal, an analysis server, and a tokenization management server, the service terminal may include the tokenization unit and a service history generating unit to generate the service history data using the tokenized ID, the analysis server may include the service history analyzing unit and the tokenized ID checking unit to analyze the service history data and display an analyzed result for a different tokenized ID considered to be the same user by the tokenized ID checking unit, and the tokenization management server may include the tokenization change management unit to manage all or some of different tokenized IDs in association with the service usage situation according to a service usage situation of a user.

According to the disclosed content, in the tokenization system, it is possible to implement privacy protection for an ID included in usage history, and to highly efficiently analyze usage history.

### BRIEF DESCRIPTION OF THE INVENTION

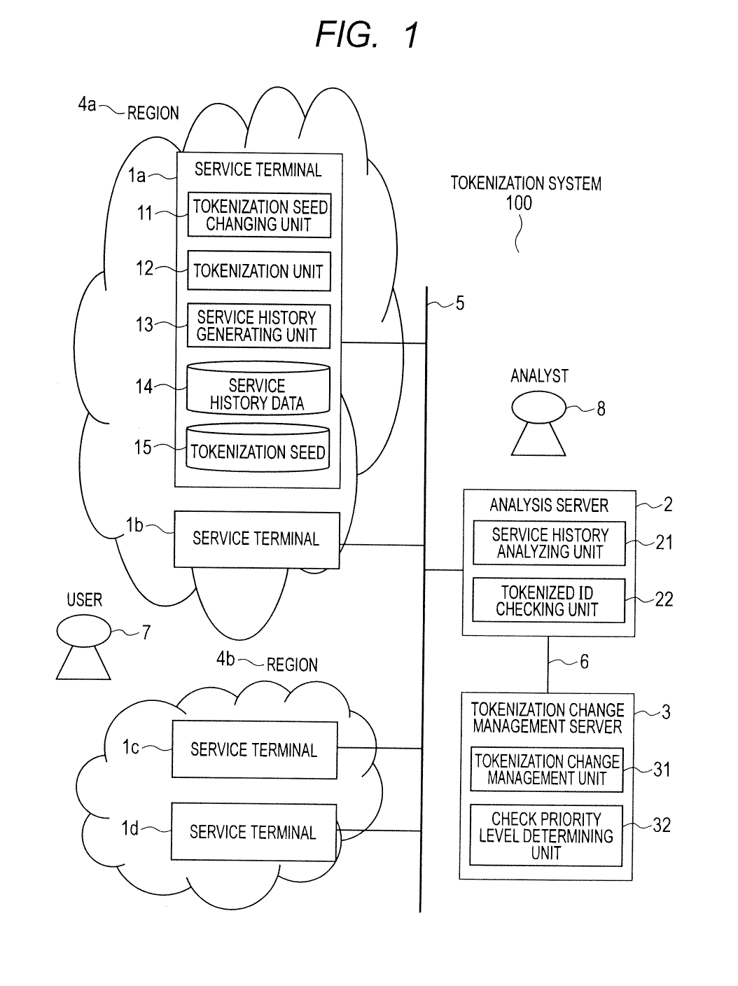

FIG. 1 is a diagram illustrating the overall configuration of a tokenization system;

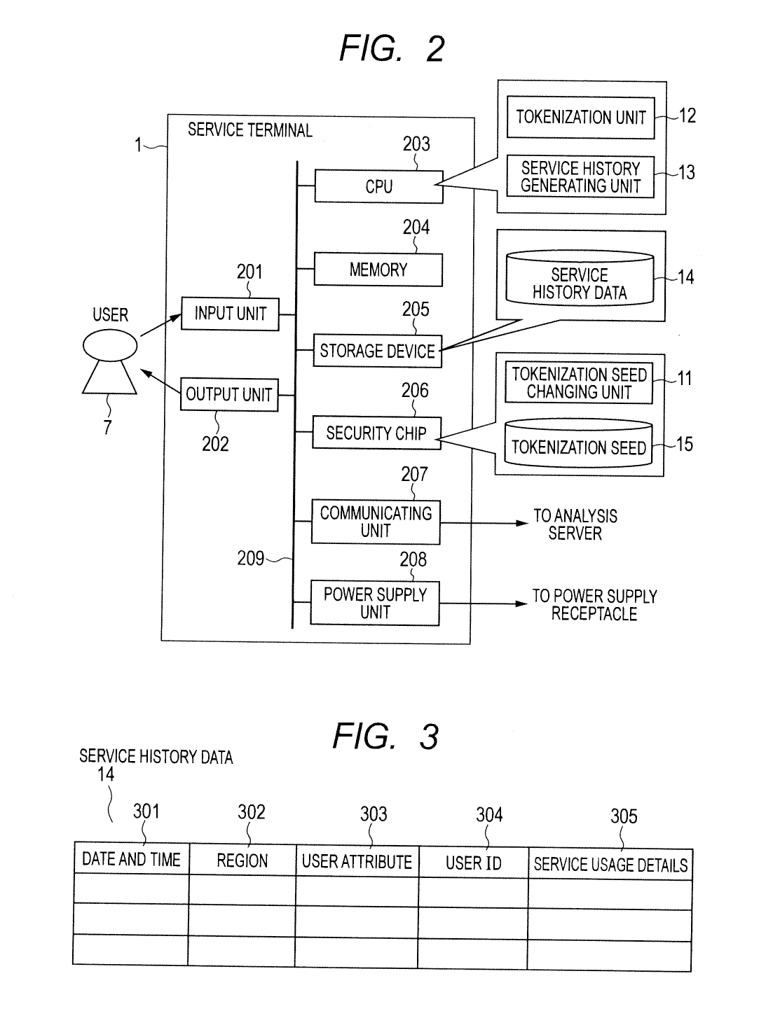

FIG. 2 is a block diagram illustrating a service terminal;

FIG. 3 is a diagram illustrating service history data;

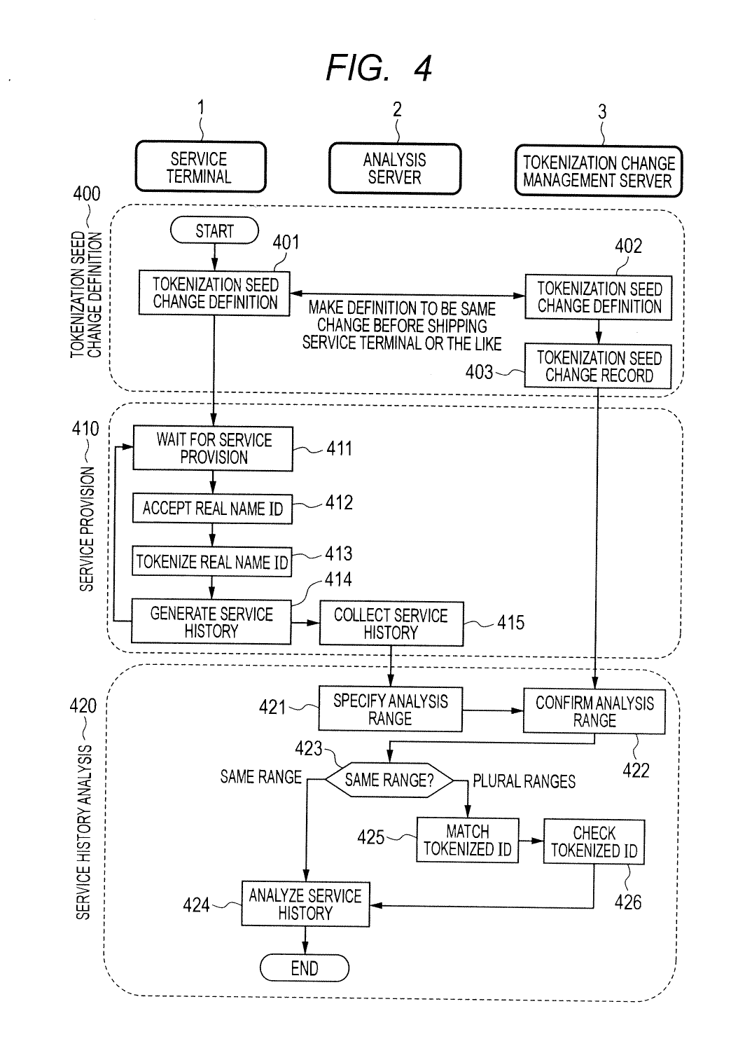

FIG. 4 is a diagram illustrating the overall sequence of a tokenization process and a tokenized ID checking process;

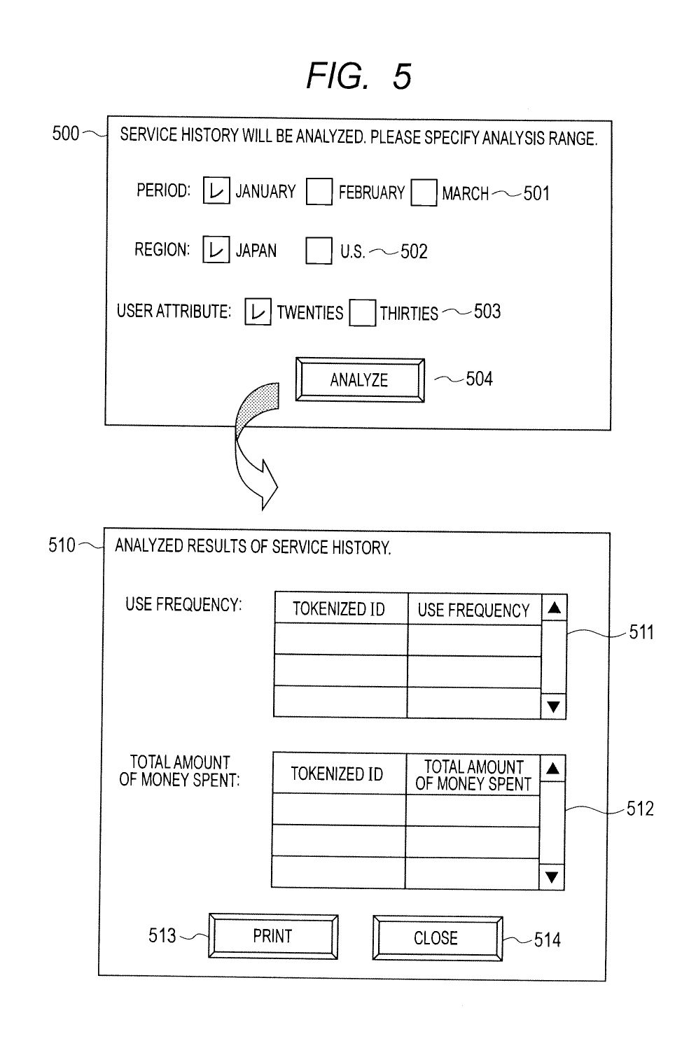

FIG. 5 is a diagram illustrating an exemplary screen interface for service history analysis;

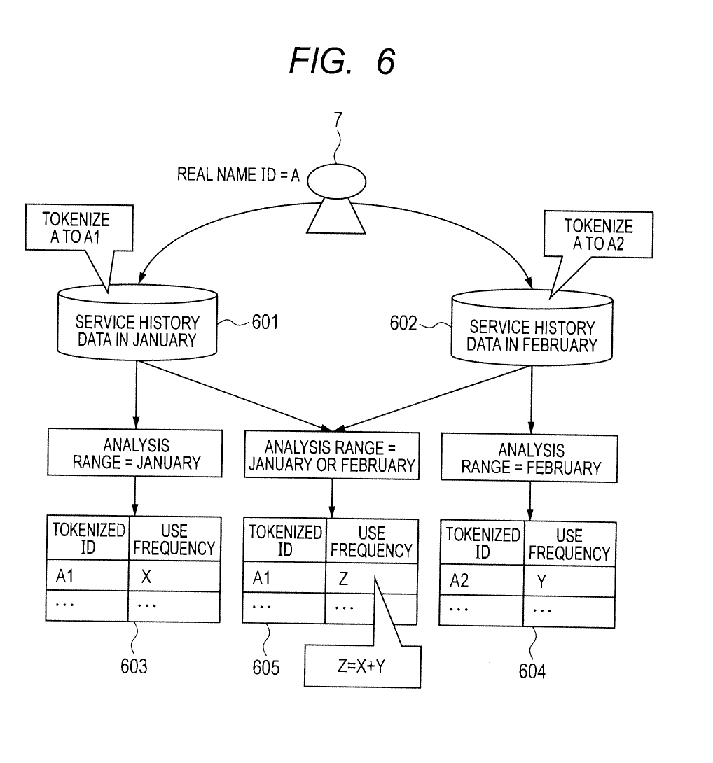

FIG. 6 is an exemplary tokenized ID checking process (changes according to periods);

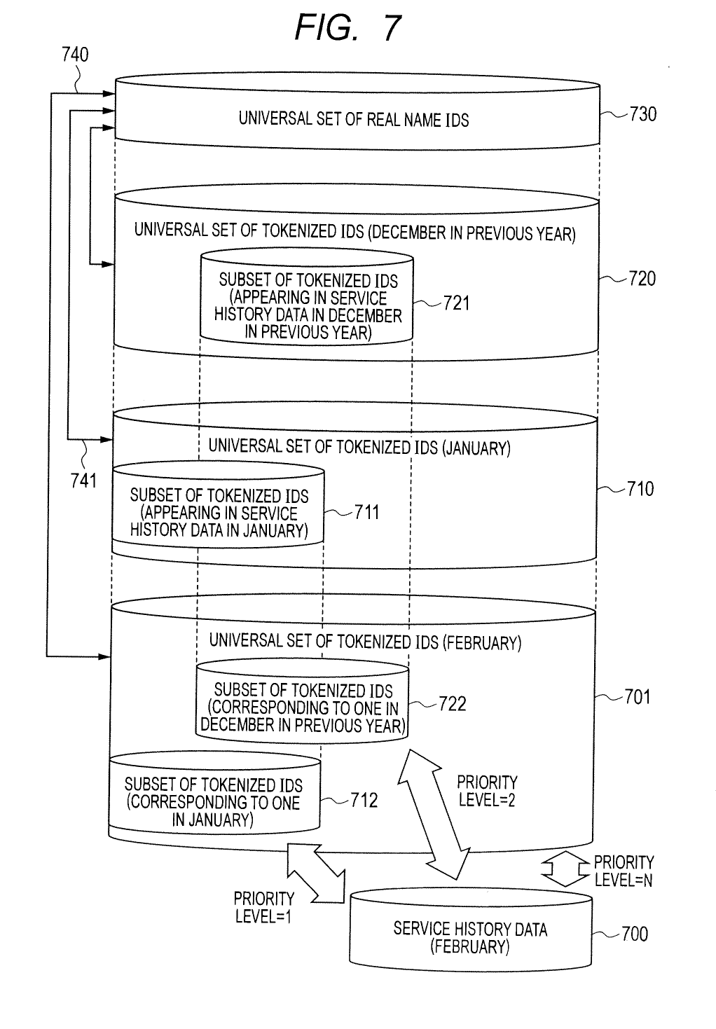

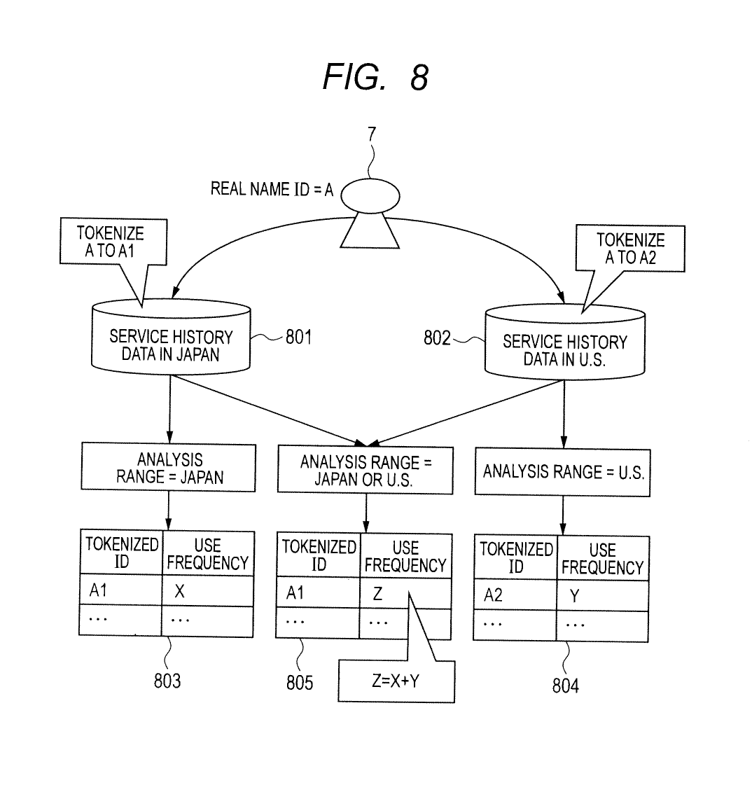

FIG. 7 is a diagram illustrating an exemplary check priority level for a tokenized ID;

FIG. 8 is a diagram illustrating an exemplary tokenized ID checking process (changes according to regions);

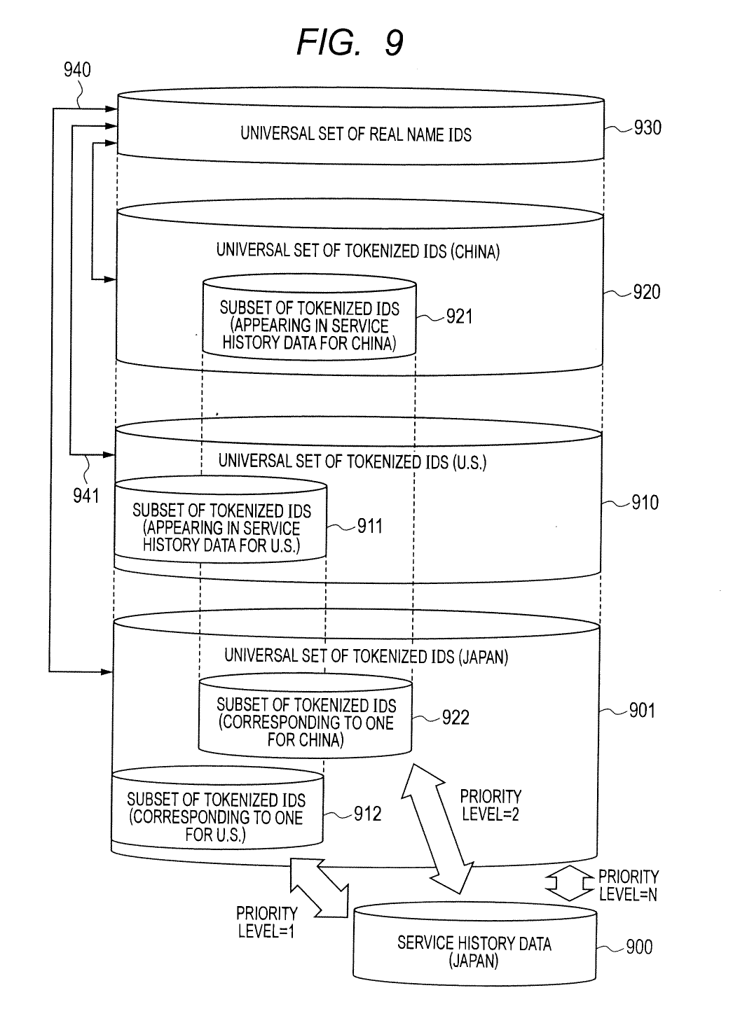

FIG. 9 is a diagram illustrating an exemplary check priority level for a tokenized ID; and

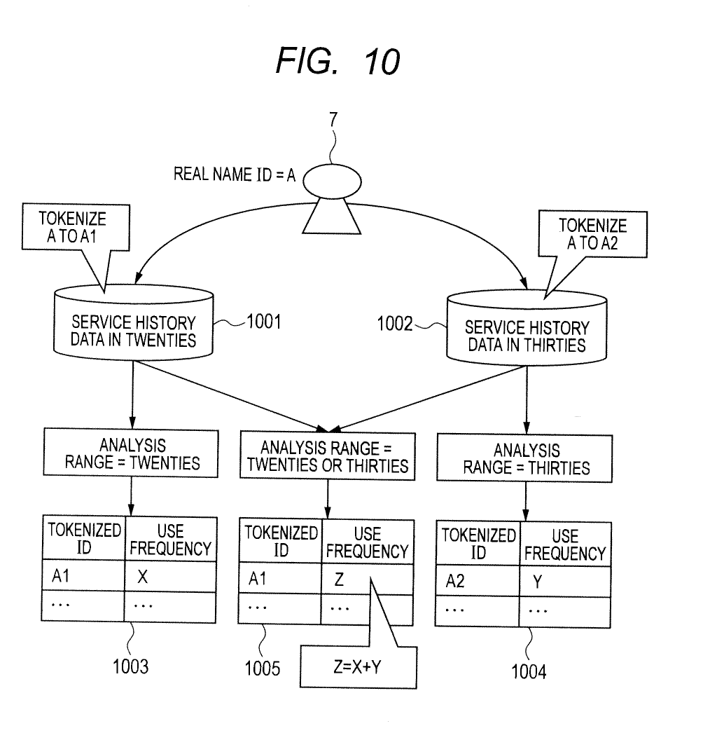

FIG. 10 is a diagram illustrating an exemplary tokenized ID checking process (changes according to user attributes).

### DETAILED DESCRIPTION OF THE PREFERRED EMBODIMENTS

A tokenization system to be illustrated below is a system that generates usage history so as not to include the real name ID of a user while offering a predetermined service to the user at a service terminal and highly efficiently links different tokenized IDs to each other in analyzing usage history at an analysis server. In the following, embodiments of the tokenization system will be described with reference to the drawings.

It is noted that the term “link” in the present specification means that behavior history is identified as the behavior history belonging to the same person. For example, since a message by a certain tokenized name can be determined as a message by the same person, the message goes into a state in which the message can be linked, and anonymity is reduced as compared with a state in which the message cannot be linked.

### First Embodiment

The overall configuration of a tokenization system 100 will be explained with reference to FIG. 1. The tokenization system 100 is configured to include service terminals 1a to 1d (sometimes generally referred to as a service terminal 1), an analysis server 2, and a tokenization change management server 3. The service terminal 1 is connected to the analysis server 2 via a network 5, and the analysis server 2 is connected to the tokenization change management server 3 via a network 6. Suppose that the service terminal 1a and the service terminal 1b are installed in a predetermined region 4a and the service terminal 1c and the service terminal 1d are installed in a predetermined region 4b. A user 7 can use any of the service terminals 1a to 1d for using a predetermined service.

The service terminal 1 includes a tokenization seed changing unit 11, a tokenization unit 12, a service history generating unit 13, service history data 14, and a tokenization seed 15. The tokenization seed changing unit 11 is responsible for changing the tokenization seed 15 for use in tokenizing a real name ID according to a predetermined rule. The tokenization unit 12 is responsible for tokenizing a real name ID using the tokenization seed 15. The service history generating unit 13 is responsible for generating the service history data 14 using a tokenized ID.

The analysis server 2 is a computer that an analyst 8 uses. The analysis server 2 includes a service history analyzing unit 21 and a tokenized ID checking unit 22. The service history analyzing unit 21 is responsible for collecting the service history data 14 from the service terminal 1 and analyzing the service history data 14. The tokenized ID checking unit 22 is responsible for again linking different tokenized IDs generated according to a predetermined rule to each other.

The tokenization change management server 3 includes a tokenization change management unit 31 and a check priority level determining unit 32. The tokenization change management unit 31 is responsible for managing the tokenization seed 15 to be changed according to a predetermined rule. The check priority level determining unit 32 is responsible for improving efficiency of checks to link different tokenized IDs generated from a single real name ID to each other in cooperation with the tokenized ID checking unit 22.

Next, a block diagram illustrating the service terminal 1 will be explained with reference to FIG. 2. The service terminal 1 can be implemented on a computer in a configuration in which an input unit 201, an output unit 202, a CPU 203, a memory 204, a storage device 205, a security chip 206, a communicating unit 207, a power supply unit 208, and the like are connected to each other through an internal communication line 209 such as a bus.

The input unit 201 is an interface through which the user 7 makes input, such as card reader, touch panel, keyboard, and voice input, for example. The output unit 202 is an interface that provides a feedback to the user 7, such as screen indication, sound indication, and prints, for example.

The CPU 203 is a central processing unit that implements the processing of the tokenization unit 12 and the service history generating unit 13, described below, by executing a program stored in the storage device 205. The memory 204 is a main storage device used by the CPU 203 when executing the program. The storage device 205 is an auxiliary storage device that stores input data to and output data from the CPU 203, the program, and the service history data 14.

The security chip 206 is an auxiliary processor and auxiliary storage device with resistance to tampering, which processes the tokenization seed changing unit 11 and stores the tokenization seed 15. The communicating unit 207 is a communication device that communicates with an external node and communicates with the analysis server 2. The power supply unit 208 is a device that supplies power to the service terminal 1 and is connected to a power supply receptacle or the like.

As similar to the block diagram illustrating the service terminal 1 in FIG. 2, the analysis server 2 and the tokenization change management server 3 can be implemented on a computer in a configuration including the input unit 201, the output unit 202, the CPU 203, the memory 204, the storage device 205, the communicating unit 207, the power supply unit 208, and the internal communication line 209 such as a bus.

The data structure of the service history data 14 will be explained with reference to FIG. 3. The service history data 14 has a data structure in a configuration including a single or more records having items of a date and time 301, a region 302, a user attribute 303, a user ID 304, and a service usage details 305. The service history generating unit 13 adds one or more records to the service history data 14 every time the user 7 receives a service at the service terminal 1. The service usage details 305 includes a purchased item, an amount of money purchased, or the like in the case where an electronic commerce service is taken as an example. Here, the service history data 14 may include at least one or more of the date and time 301, the region 302, and the user attribute 303, or a combination thereof. For simplifying the explanation, suppose that only the date and time 301 is included in the first embodiment.

Next, the overall sequence of performing a tokenization process and a tokenized ID checking process in cooperation with the service terminal 1, the analysis server 2, and the tokenization change management server 3 will be explained with reference to FIG. 4 using the system block diagram and the data structure described above. The overall sequence mainly includes three phases, a tokenization seed change definition phase 400, a service provision phase 410, and a service history analysis phase 420.

In the tokenization seed change definition phase 400, first, the service terminal 1 and the tokenization change management server 3 determine a rule of changing the tokenization seed 15 in cooperation (Steps 401 and 402). For example, the tokenization seed changing unit 11 and the tokenization seed 15 are prevented from being tampered, destroyed, erased, or the like, in which the tokenization seed changing unit 11 and the tokenization seed 15 are stored in the security chip 206 for a changing rule before shipping the service terminal 1 and the security chip 206 with the resistance to tampering is used after shipping.

In the first embodiment, for an exemplary changing rule, the tokenization seed is changed every month.

Steps 401 and 402 are not necessarily performed by the service terminal 1 and the tokenization change management server 3. Steps 401 and 402 may be processed manually. Alternatively, as for Steps 401 and 402, the service terminal 1 may inquire the tokenization change management server 3 whether the tokenization seed 15 is needed to change via the network 5 and the network 6. The tokenization change management server 3 records all of the tokenization seeds 15 changed according to the changing rule (Step 403).

Subsequently, in the service provision phase 410, the process is started in a state in which the service terminal 1 waits for service provision for the user 7 (Step 411). When the service terminal 1 starts to provide a service for the user 7, the input unit 201 accepts a real name ID as by reading a card, for example (Step 412). The accepted real name ID is tokenized to a tokenized ID by the tokenization unit 12 (Step 413). Here, for an example of tokenization, the real name ID and the tokenization seed 15 are combined and subjected to a one-way function for generating a tokenized ID. The tokenization seed 15 is changed every month, so that a tokenized ID in a certain month is different from a tokenized ID in the subsequent month for even the same real name ID. The service history generating unit 13 uses the tokenized ID to add to the service history data 14 one or more records including the date and time 301, the user ID 304, and the service usage details 305. The service terminal 1 again returns to the state in which the service terminal 1 waits for a service in Step 411 (Step 414).

In the service provision phase 410, the analysis server 2 collects the service history data 14 from the service terminal 1 at regular time intervals or according to the operation of the analyst 8 (Step 415). After making a confirmation of collection, the service history data 14 may be erased from the storage device 205 of the service terminal 1.

In the service history analysis phase 420, first, the analyst 8 specifies what range to be analyzed in the service history data 14 (Step 421).

An exemplary interface through which the analysis specifies a range will be explained with reference to FIG. 5. A screen 500 is constituted of a check box 501 that specifies a period, a check box 502 that specifies a region, a check box 503 that specifies a user attribute, and an analysis button 504. In the first embodiment, the check box 502 that specifies a region and the check box 503 that specifies a user attribute are not used. The analyst 8 marks the check box 501 for a month to be an analysis range at the check box 501 that specifies a period, presses the analysis button 504, and then starts analysis.

In the subsequent step in the service history analysis phase 420, the tokenization change management unit 31 is inquired about the analysis range to confirm whether only the tokenized ID generated according to the same tokenization seed 15 is included in the analysis range (Step 422). The subsequent process is branched according to the confirmed result in Step 422 (Step 423).

In Step 423, if only the tokenized ID generated according to the same tokenization seed 15 is included in the analysis range, the service history analyzing unit 21 analyzes the service history data 14 and displays the analyzed result (Step 424).

An exemplary interface on which the analyzed result is displayed will be explained with reference to FIG. 5. A screen 510 is constituted of a list box 511 that indicates the analyzed result of a use frequency, a list box 512 that indicates the analyzed result of the total amount of money spent, a print button 513, and a close button 514 in the specified period. The analyst 8 can know which tokenized ID uses services how may times with reference to the list box 511 for the use frequency. Furthermore, the analyst 8 can know which tokenized ID uses how many services with reference to the list box 512 for the total amount of money spent.

Again in the service history analysis phase 420, in Step 423, if only the tokenized ID generated according to the same tokenization seed 15 is not included in the analysis range, the tokenized ID checking unit 22 inquires the tokenization change management unit 31 and examines whether a tokenized ID in a certain month is the same as a tokenized ID in another month (Steps 425 and 426). After linking the same tokenized IDs to each other, the service history analyzing unit 21 analyzes the service history data 14 (Step 424).

In order to explain the overall sequence diagram described above more in detail, an explanation will be given together with a specific example with reference to FIG. 6.

In FIG. 6, suppose that there are service history data 601 for January generated from the result of using the service terminal 1 in January and service history data 602 for February generated from the result of using the service terminal 1 in February. Supposing the real name ID of the user 7 is “A”, “A” is tokenized to “A1” in the service history data 601 for January and “A” is tokenized to “A2” in the service history data 602 for February.

The analyst 8 is to make three types of analyses using the service history data 601 and the service history data 602 for input.

1. An analysis 603 for the service history data for January.
2. An analysis 604 for the service history data for February.
3. An analysis 605 for the service history data for January or February.
The analysts can be switched by the analyst 8 to specify the check box 501 for the periods shown in FIG. 5.

In the analysis 603, since the service history of the real name ID “A” is all recorded as the tokenized ID “A1”, the use frequency, the total amount of money spent, or the like related to the tokenized ID “A1” can be calculated by analyzing the service history data 601 as it is. For explanation, suppose that the use frequency is X times.

Similarly in the analysis 604, since the service history of the real name ID “A” is all recorded as the tokenized ID “A2”, the use frequency, the total amount of money spent, or the like related to the tokenized ID “A2” can be calculated by analyzing the service history data 602 as it is. For explanation, suppose that the use frequency is Y times.

Lastly in the analysis 605, the tokenized IDs “A1” and “A2” are mixed in the service history of the real name ID “A”. However, according to the service history data 14 shown in FIG. 3, since the user ID 304 and the date and time 301 are paired and recorded, it is expected that the user ID “A1” will appear in January and the user ID “A2” will appear in February if the date and time 301 is confirmed. Here, the user ID “A2” appearing in January and the user ID “A1” appearing in February may be processed as error. Whether the user ID “A1” appearing in January and the user ID “A2” appearing in February belong to the same user can be confirmed by inquiring the tokenization change management server 3. Thus, it is possible to calculate that the user of the tokenized ID “A1” uses services for Z (=X+Y) times from January to February.

The process of the check priority level determining unit 32 of the tokenization change management server 3 will be explained with reference to FIG. 7. Here, suppose that the analysis range is for January or February, a tokenized ID included in service history data 700 for February is to be checked against a universal set 710 of tokenized IDs for January.

For simple checking, such a method may be possible that a search is made which tokenized ID included in the universal set 701 for February falls in a tokenized ID included in the service history data 700, a universal set 730 of real name IDs linked to the universal set 701 for February through an association 740 is searched for a real name ID, and the universal set 710 of the tokenized ID for January linked to the universal set 730 through an association 741 is searched for the tokenized ID.

The check priority level determining unit 32 generates beforehand a subset 711 of tokenized IDs appearing in the service history data for January from the universal set 710 of the tokenized ID for January, and a subset 712 of tokenized IDs for February linked to the subset 711. The subsets are checked against the service history data 700 for February as the subset 712 is at a first priority level.

Similarly, a subset 721 of tokenized IDs appearing in service history data for December in the previous year is generated beforehand from a universal set 720 of tokenized IDs for December in the previous year, and a subset 722 of tokenized IDs for February linked to the subset 721 is generated beforehand. The subsets are checked against the service history data 700 for February as the subset 722 is at a second priority level.

Subsequently, a subset of tokenized IDs for February is generated beforehand as going back to the past, and the subset is checked against the service history data 700. Lastly, a check is made against the universal set 701 of tokenized IDs for February. Alternatively, a check may be canceled on the way of sequentially going back to the past.

As described above, the check priority level determining unit 32 determines priority level to sequentially search each subset, so that it is possible to highly efficiently find a tokenized ID that tends to be hit as compared with a thorough search of the universal set of tokenized IDs.

Hereinabove, the tokenization system 100 according to the first embodiment is described. According to the tokenization system 100, it is possible to make it difficult to link a tokenized ID included in service history data for a long time, and it is possible to highly efficiently analyze service history data even for a long time.

### Second Embodiment

A tokenization system according to a second embodiment takes the same system configuration as the system configuration of the tokenization system 100 shown in FIG. 1. This embodiment is different from the first embodiment in that in the service history data 14 shown in FIG. 3, the combination of the columns of the region 302 and the user ID 304 is always included and in the tokenization seed change definition phase 401 shown in FIG. 4, the tokenization seed 15 is varied depending on the region 4a and the region 4b shown in FIG. 1.

A specific example of a checking process of a tokenized ID according to the second embodiment will be explained with reference to FIG. 8. In FIG. 8, suppose that there are service history data 801 for Japan generated from the result of using a service terminal 1 in Japan and service history data 802 for the United States from the result of using the service terminal 1 in the United States. Supposing the real name ID of a user 7 is “A”, “A” is tokenized to “A1” in the service history data 801 for Japan, and “A” is tokenized to “A2” in the service history data 802 for the United States.

An analyst 8 is to perform three types of analyses using the service history data 801 and the service history data 802 for input.

1. An analysis 803 for the service history data for Japan.
2. An analysis 804 for the service history data for the United States.
3. An analysis 805 for the service history data for Japan and the United States.
The analyses can be switched by the analyst 8 to specify the check box 502 for regions shown in FIG. 5.

In the analysis 803, since the service history of the real name ID “A” is all recorded as the tokenized ID “A1”, the use frequency, the total amount of money spent, or the like related to the tokenized ID “A1” can be calculated by analyzing the service history data 801 as it is. For explanation, suppose that the use frequency is X times.

Similarly in the analysis 804, since the service history of the real name ID “A” is all recorded as the tokenized ID “A2”, the use frequency, the total amount of money spent, or the like related to the tokenized ID “A2” can be calculated by analyzing the service history data 802 as it is. For explanation, suppose that the use frequency is Y times.

Lastly in the analysis 805, the tokenized IDs “A1” and “A2” are mixed in the service history of the real name ID “A”. However, according to the service history data 14 shown in FIG. 3, since the user ID 304 and the region 302 are paired and recorded, it is expected that the user ID “A1” will appear in Japan and the user ID “A2” will appear in the United States if the region 302 is confirmed. Here, the user ID “A2” appearing in Japan and the user ID “A1” appearing in the United States may be processed as error. Whether the user ID “A1” appearing in Japan and the user ID “A2” appearing in the United States belong to the same user can be confirmed by inquiring a tokenization change management server 3. As described above, it is possible to calculate that the user of the tokenized ID “A1” uses services for Z (=X+Y) times in Japan and the United States.

Next, the process of a check priority level determining unit 32 of a tokenization change management server 3 will be explained with reference to FIG. 9. Here, a tokenized ID included in the service history data 900 for Japan is to be checked against a universal set 910 of tokenized IDs for the United States as an analysis range is Japan and the United States.

The check priority level determining unit 32 generates beforehand a subset 911 of tokenized IDs appearing in the service history data for the United States from the universal set 910 of tokenized IDs for the United States, and a subset 912 of tokenized IDs for Japan linked to the subset 911. The subsets are checked against the service history data 900 for Japan as the subset 912 is at a first priority level.

Similarly, a subset 921 of tokenized IDs appearing in the service history data for China is generated beforehand from a universal set 920 of tokenized IDs for China, and a subset 922 of tokenized IDs for Japan linked to the subset 921 is generated beforehand. The subsets are checked against the service history data 900 for Japan as the subset 922 is at a second priority level.

Subsequently, a subset of tokenized IDs for Japan is generated beforehand in order of regions closer to Japan, and the subset is checked against the service history data 900. Lastly, a check is made against the universal set 901 of tokenized IDs for Japan. Alternatively, a check may be canceled in order of regions closer to Japan on the way of checking.

As described above, the check priority level determining unit 32 determines priority level to sequentially search each subset, so that it is possible to find a tokenized ID that tends to be hit in priority as compared with a thorough search of the universal set of tokenized IDs.

According to the second embodiment as described above, it is possible to make it difficult to link a tokenized ID included in service history data across regions, and it is possible to highly efficiently analyze service history data even in an analysis across regions.

### Third Embodiment

A tokenization system according to a third embodiment takes the same system configuration as the system configuration of the tokenization system 100 shown in FIG. 1. This embodiment is different from the first embodiment in that in the service history data 14 shown in FIG. 3, the combination of the columns of the user attribute 303 and the user ID 304 is always included and in the tokenization seed change definition phase 401 shown in FIG. 4, the tokenization seed 15 is varied depending on the user attribute 303. It is noted that the user attribute includes generations, genders, hobbies, an amount of money purchased, or the like, and the user attribute may be input by a user 7 or a salesclerk, not shown.

A specific example of a checking process of a tokenized ID according to the third embodiment will be explained with reference to FIG. 10. In FIG. 10, suppose that there are service history data 1001 for the twenties generated from the result of using a service terminal 1 as the twenties and service history data 1002 for the thirties from the result of using the service terminal 1 as the thirties. Supposing the real name ID of the user 7 is “A”, “A” is tokenized to “A1” in the service history data 1001 for the twenties, and “A” is tokenized to “A2” in the service history data 1002 for the thirties.

An analyst 8 is to perform three types of analyses using the service history data 1001 and the service history data 1002 for input.

1. An analysis 1003 for the service history data for the twenties.
2. An analysis 1004 for the service history data for the thirties.
3. An analysis 1005 for the service history data for the twenties or the thirties.
The analyses can be switched by the analyst 8 to specify the check box 503 for user attributes shown in FIG. 5.

In the analysis 1003, since the service history of the real name ID “A” is all recorded as the tokenized ID “A1”, the use frequency, the total amount of money spent, or the like related to the tokenized ID “A1” can be calculated by analyzing the service history data 1001 as it is. For explanation, suppose that the use frequency is X times.

Similarly in the analysis 1004, since the service history of the real name ID “A” is all recorded as the tokenized ID “A2”, the use frequency, the total amount of money spent, or the like related to the tokenized ID “A2” can be calculated by analyzing the service history data 1002 as it is. For explanation, suppose that the use frequency is Y times.

Lastly in the analysis 1005, the tokenized IDs “A1” and “A2” might be mixed in the service history of the real name ID “A”. However, according to the service history data 14 shown in FIG. 3, since the user ID 304 and the user attribute 303 are paired and recorded, it is expected that the user ID “A1” will appear in the twenties and the user ID “A2” will appear in the thirties if the user attribute 303 is confirmed. Here, the user ID “A2” appearing in the twenties and the user ID “A1” appearing in the thirties may be processed as error. Whether the user ID “A1” appearing in the twenties and the user ID “A2” appearing in the thirties belong to the same user can be confirmed by inquiring a tokenization change management server 3. As described above, it is possible to calculate that the user of the tokenized ID “A1” uses services for Z (=X+Y) times in the twenties or the thirties.

According to the third embodiment as described above, it is possible to make it difficult to link a tokenized ID included in service history data beyond user attributes.

Hereinabove, the embodiments of the present invention are described specifically. The present invention is not limited to these embodiments, which can be modified and altered without departing from the teachings thereof.

What is claimed is:

1. A tokenization system to tokenize a real name ID in generating a user's service history data, the tokenization system comprising:
a tokenization unit configured to tokenize a real name ID to a different tokenized ID according to a situation in which a user uses a service;
a service history analyzing unit configured to analyze service history data;
a tokenized ID checking unit configured to determine whether different tokenized IDs are the same in analyzing a plurality of items of service history data including the different tokenized IDs; and
a tokenization change management unit configured to manage a different tokenized ID according to a service usage situation in association with the service usage situation,
wherein the service history analyzing unit performs:
a predetermined service history analysis if a target is a service usage situation in which a same tokenized ID appears; and
a predetermined service history analysis for a different tokenized ID that is considered to be a same user by the tokenized ID checking unit if a target is a service usage situation in which a different tokenized ID appears.

2. The tokenization system according to claim 1,
wherein the tokenization unit tokenizes a real name ID to a different tokenized ID according to a combination of any one or more of a date and time in using a service, a region in using a service, and a user attribute in using a service.

3. The tokenization system according to claim 1,
wherein the tokenization change management unit, according to an analysis range in which an analysis is made in the service history analyzing unit, finds a service usage situation close to the analysis range, and prepares a subset of a tokenized ID appearing in the service usage situation; and
the tokenized ID checking unit makes a check against the subset of the tokenized ID in order closer to the analysis range.

4. The tokenization system according to claim 3,
wherein when sequentially making a check against the subset of the tokenized ID in order closer to the analysis range, the tokenized ID checking unit makes a check against a universal set of a tokenized ID as a last order, or cancels a check on a way of checking in sequentially making a check against the subset of the tokenized ID.

5. The tokenization system according to claim 1,
wherein the service history data includes a user ID, a service usage details, and a combination of any one or more of a date and time, a region, and a user attribute.

6. A service terminal for use in the tokenization system according to claim 1, comprising:
the tokenization unit; and
a service history generating unit configured to generate the service history data using the tokenized ID.

7. An analysis server for use in the tokenization system according to claim 1, comprising:
the service history analyzing unit and the tokenized ID checking unit,
wherein the service history analyzing unit analyzes the service history data and displays an analyzed result for a different tokenized ID considered to be a same user by the tokenized ID checking unit.

8. A tokenization management server for use in the tokenization system according to claim 1, comprising:
the tokenization change management unit,
wherein the tokenization change management unit manages all or some of different tokenized IDs in association with the service usage situation according to a service usage situation of a user.
